(19) United States
(12) Patent Application Publication
(10) Pub. No.: US 2006/0235095 A1
(43) Pub. Date: Oct. 19, 2006

(54) Method for the production of expanding thermoplastic elastomers

(75) Inventors: Marcus Leberfinger, Georgsmarienhuette (DE); Carsten Günther, Wagenfeld (DE); Berend Eling, Lemförde (NL)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/558,417

(22) PCT Filed: Jun. 4, 2004
(86) PCT No.: PCT/EP04/06034

§ 371 Date: Nov. 29, 2005

(30) Foreign Application Priority Data
Jun. 6, 2003 (DE) 103 26 138.9

(51) Int. Cl. C08J 9/16

(52) U.S. Cl. 521/56

(57) ABSTRACT

The invention relates to expandable thermoplastic polyurethanes, capable of preparation via mixing of thermoplastic polyurethanes with expandable microspheres, wherein the expandable microspheres have a TMA density smaller than 10 kg/m³.

Thermoplastic polyurethanes (TPUs) are semicrystalline materials within the class of thermoplastic elastomers. They feature, inter alia, good strengths, abrasion properties, tear propagation resistance properties, and chemicals resistance, and can be produced at almost any desired hardness via a suitable mix of raw materials.

They are prepared in the known processes by a one-shot or prepolymer method, on a belt system or in a reactive extruder. The reaction components here, these being diisocyanate, long-chain diol, and short-chain diol (chain extender) are combined together or in a certain sequence, and reacted. When the reaction partners are mixed, the ratio between the NCO groups and the total of all the hydrogen atoms reacting with the NCO groups is 1: from 0.9 to 1.2, preferably 1: from 0.95 to 1.05, in particular 1:1.

It is well-known that thermoplastics (TPEs) can be foamed, using blowing agents. In particular, foaming of polystyrene and polyolefins is widely practiced.

Blowing agents used here are chemical blowing agents, such as citric acid, hydrogencarbonates, or azodicarbonamides, such as Celegoene; Tracel; Hydrocerole products, etc. (“Hydrocerole: chemische Treib- und Nukleierungsmittel für Kunststoffe; Verarbeitungshinweise; Spritzguss; Hart-PVC-Schaum; Schaumextrusion; Produktprogramm; Clariant März 2000”; “Neue Treibmittelentwicklungen im Bereich Spritzguss; Lübke, G.; Holzberg, T.; Seminare zur Kunststoffverarbeitung IKV; Feb. 4, 2003”), or physical blowing agents, which are inert liquids that evaporate under the conditions of foaming, or expandable microspheres (e.g. Expancel® from Akzo or Microspheres from Lehmann & Voss). Combinations of chemical blowing agents and expandable microspheres may also be used (Foaming Plastics with Expancel Microspheres: Elfving, K.; Blowing Agent Systems: Formulations and Processing; Paper 9, page 1-5; Mikrohohlkugeln aus Kunststoffen; N. N.; Kunststoffe 82 (1992) 4 (36366).

There are also known processes which use blowing agents to foam thermoplastic polyurethanes. In the case of TPUs, chemical blowing agents give a relative coarse foam structure and increase the degree of cavitation.

EP-A-692 516 describes a process for producing TPU-based foams in which a mixture of chemical blowing agents and Expancel® microspheres is used as blowing agent to counter that shortcoming.

Expandable microspheres are hollow microbeads which are composed of a thin plastics shell, such as polyacrylnitrile or copolymers thereof. These hollow microbeads are gas-filled, generally using hydrocarbons. The temperature to which the material is exposed during thermoplastic processing causes the plastics shell to soften and simultaneously causes the enclosed gas to expand. The result is that the microspheres expand. The expandability of the microspheres may be described by determining their TMA density [kg/m³] (Mettler Toledo Stare thermal analysis system; heating rate 20° C./min). The TMA density here is the minimum achievable density at a certain temperature Tₘₐₓ at atmospheric pressure prior to collapse of the microspheres.

WO 00/44821 proposes the use of a blowing agent combination composed of microspheres of Expancel® type, the microspheres in this combination having been filled with hydrocarbons.

EP-A-1174459 improves the process described in WO 00/44821 by adding a flow aid to the TPU. This is intended to improve the surface of the moldings and to reduce the molding time.

EP-A-1174458 is intended to achieve the same effect via addition of plasticizers.

However, it has been found that even the moldings produced by these processes have a comparatively coarse foam structure and have cavities.

Processing latitude has also been found to be very restricted. If processing takes place outside the range concerned, the densities desired can firstly not be achieved, i.e. the foam collapses, and the formation of cavities is secondly observed to increase, this being visible in the cross section of the finished molding, e.g. a shoe sole, or even leading to visible depressions on the surface. The use of holding pressure during injection molding to compensate for these depressions is not possible here, because that procedure leads to rapid collapse or compression of the foam in the mold and therefore would fail to achieve an adequate density reduction. These disadvantages are serious problems in particular at low densities.

Cavities are comparatively large gas bubbles which are distinguishable from the finer foam structure which surrounds them, and, by way of example, are discernible on contact with the material, or by way of visible depressions on the surface of the final product.

It is an object of the present invention to produce expanded TPUs with a density of <1.2 g/cm³, preferably from 0.3 to 1.0 g/cm³, particularly preferably from 0.4 to 0.8 g/cm³, with a high degree of processing latitude in injection molding and in the extrusion process, via the use of a suitable blowing agent, without formation of cavities and without depressions. Because the blowing agents to be used are mostly the factors which drive costs, the intention was at the same to reduce the amount of blowing agent used, for comparable densities.

We have found that this object is achieved by using expandable microspheres, preferably in the form of powder, or particularly preferably bound in the form of masterbatches, the expandable microspheres used having a TMA density smaller than 10 kg/m³, preferably from 2 to 10 kg/m³ and particularly preferably from 2 to 7 kg/m³, in particular from 2 to 6 kg/m³.

It has been found that the use of expandable microspheres with a TMA density smaller than 10 kg/m³, preferably from 2 to 10 kg/m³, and particularly preferably from 2 to 7 kg/m³, in powder form or in masterbatch form, differs from the use of purely chemical blowing agents or mixtures of chemical blowing agents with expandable microspheres whose TMA density is outwith the inventive range, in providing a markedly finer cell structure, no cavitation, and no formation of depressions, and moreover in providing a marked increase in processing latitude, for example in relation to temperature.

A particular advantage is that there is no need to use any other blowing agents alongside the inventive expandable microspheres. It is therefore preferable that no other blowing agents, in particular no chemical blowing agents, are used in addition to the expandable microspheres, in particular in addition to the inventive expandable microspheres.

If the TPUs are treated with these microspheres and subjected to thermoplastic processing, the result is a reduction in the density of the final product.

The invention therefore provides a process for producing expanded TPUs, comprising the steps of
a) mixing blowing agents with a TPU and, where appropriate, drying,
b) thermoplastic processing of this mixture with expansion of the blowing agent, which comprises using, as blowing agents, expandable microspheres with a TMA density smaller than 10 kg/m³, preferably from 2 to 10 kg/m³, and particularly preferably from 2 to 7 kg/m³.

The invention also provides expanded TPUs produced by this process. These preferably have a density of <1.2 g/cm³, preferably from 0.3 to 1.0 g/cm³, and particularly preferably from 0.4 to 0.8 g/cm³.

The invention also provides expandable TPUs, comprising expandable microspheres with a TMA density smaller than 10 kg/m³, preferably from 2 to 10 kg/m³, and particularly preferably from 2 to 7 kg/m³.

The inventive microspheres preferably have a diameter of from 20 μm to 40 μm. Corresponding microspheres are obtainable from Akzo Nobel, Casco Products GmbH, Essen, with the trademark Expancel® 093 DU 120 (Powder).

For the purposes of the present invention, the expression “thermoplastic processing” means any process associated with melting of the TPU. This thermoplastic processing takes place at from 80 to 240° C., preferably from 120 to 230° C., particularly preferably at from 170 to 220° C., in injection-molding and extrusion plants or powder-centering plants, these being known to the person skilled in the art.

The content of expandable microspheres in the mixture depends on the desired density of the expanded TPUs. For each 100 parts by weight of the TPU or TPU blend to be expanded, i.e. to be foamed, it is preferable to use from 0.1 to 10 parts by weight, with preference from 0.2 to 6.5 parts by weight, of the inventive expandable microspheres.

Particular preference is given to expandable or expanded TPUs which comprise the following components:
from 85 to 99.5% by weight, preferably from 90 to 99.5% by weight, particularly preferably from 92 to 98% by weight, of TPU or blend comprising TPU, from 0.5 to 15% by weight, preferably from 2 to 8% by weight, of microspheres masterbatch, from 0 to 10% by weight, preferably from 0.1 to 2% by weight, of dye, e.g. well-known black paste or dyes added in the form of color masterbatches.
The microspheres masterbatch preferably comprises:

from 5 to 90% by weight, preferably from 25 to 65% by weight, of microspheres, and from 10 to 95% by weight, preferably from 35 to 75% by weight, of carriers, preferably thermoplastic carriers, for example the carrier materials described hereinafter, particularly preferably EVA (ethylene-vinyl acetate).

Expanded TPUs which have a fine, cavity-free foam structure free from depressions are produced over a wide range of process conditions by using the expandable microspheres used according to the invention. One possible reason for this is that expandable microspheres with low TMA density exert a greater internal pressure during filling of the mold, thus markedly reducing or eliminating the risk of formation of cavities and depressions, this also being achieved in conventional injection molding, by way of example, solely by applying an external holding pressure, with no use of any blowing agent.

These low TMA densities can also minimize the proportion by weight of microspheres used for comparable density. This leads to cost savings, because the microspheres are generally the price-determining factor with regard to the raw materials of the finished product.

Surprisingly, the use of concomitant blowing agents can be omitted entirely when using the expandable microspheres used according to the invention. However, in the case of certain applications use may also be made of concomitant blowing agents.

The expandable microspheres used according to the invention may, as described, be used in the form of powder, and in this case the application to the TPU pellets may take place with or without binders, such as from 0.05 to 2% by weight of mineral oil or of paraffin oil, or they may preferably be used in the form of masterbatches. For the purposes of the present invention, a masterbatch is a pellet material in which the expandable microspheres have been bound within a carrier, such as a binder, wax, or a thermoplastic, e.g. TPU, EVA (ethylene-vinyl acetate), polyvinyl chloride, polyethylene, polypropylene, polyester, polystyrene, or thermoplastic rubber, or blends composed thereof, preferably in a carrier with a melt index (MFR; 190° C./2.16 kg; ASTM D1238) of from 5 to 700 g/10 min., preferably from 50 to 600 g/10 min., particularly preferably from 150 to 500 g/10 min., and with a melting point of from 60 to 110° C., particular preference being given to EVA. The preparation of these microsphere masterbatches generally uses thermoplastics with a very low melting point and with very low viscosities or high melt indices, as described above, in order thus to permit use of minimum temperatures during masterbatch preparation and thus avoid premature expansion.

The use of these masterbatches avoids the dusting which arises during the use and handling of expandable microspheres in powder form, and when this method is used it is possible to omit costly explosion protection of the plants and buildings in which the inventive expanded TPUs are produced. In addition, the homogeneous mixing of the expandable microspheres with the TPU is easier when masterbatches are used. By way of example, the microsphere masterbatches may be prepared in kneaders or in single- or twin-screw extruders.

The TPUs used may comprise the conventional and known compounds, as described by way of example in Kunststoffhandbuch, volume 7 “Polyurethane”, Carl Hanser Verlag, Munich, Vienna, 3^{rd} edition, 1993, pp. 455-466.

Preference is given to the use of TPUs which have a melt index or MFR (melt flow ratio; 190° C./3.8 kg; DIN EN 1133) of from 1 to 350 g/10 min., preferably from 30 to 150 g/10 min. However, the use of TPUs for expandable or expanded TPUs is not restricted to any particularly MFR.

For the purposes of the present invention, TPUs are unplasticized and plasticized TPUs, in particular those whose content of conventional plasticizer is from 0 to 50% by weight, based on the weight of the mixture. The plasticizers which may generally be used comprise compounds well-known for this purpose, e.g. phthalates and in particular benzoates.

Furthermore, for the inventive process it is also possible to use blends of TPU with, based on the weight of the blend, up to 70% by weight of another plastic from the group consisting of the thermoplastics, in particular from the group consisting of the thermoplastic elastomers or rubbers. Preference is given to mixtures comprising TPUs and other thermoplastic elastomers, and comprising from 99 to 50% by weight of TPUs and from 1 to 50% by weight of another thermoplastic elastomer, particularly preferably from 90 to 70% by weight of TPUs and from 10 to 30% by weight of another thermoplastic elastomer. Other thermoplastic elastomers which may preferably be used are, by way of example, rubbers, e.g. butadiene-acrylnitrile copolymers.

The TPUs are prepared by a conventional process, via reaction of diisocyanates with compounds having at least two hydroatoms reactive toward isocyanate groups, preferably with dihydric alcohols.

The diisocyanates used may comprise conventional aromatic, aliphatic, and/or cycloaliphatic diisocyantes, e.g. diphenylmethane diisocyanate (MDI), toluene diisocyanate (TDI), tri-, tetra-, penta-, hexa-, hepta- and/or octamethylene diisocyanate, 2-methylpentamethylene 1,5-diisocyanate, 2-ethylbutylene 1,4-diisocyanate, 1-isocyanato-3,3,5-trimethyl-5-isocyanatomethylcyclohexane (isophoron diisocyanate, IPDI), 1,4- and/or 1,3-bis(isocyanatomethyl)cyclohexane (HXDI), cyclohexane 1,4-diisocyanate, 1-methyl cyclohexane 2,4- and/or 2,6-diisocyanate, dicyclohexylmethane 4,4′-, 2,4′- and/or 2,2′-diisocyanate.

The compounds used which are reactive toward isocyanates may comprise well-known polyhydroxy compounds with molecular weights of from 500 to 8,000, preferably from 600 to 6,000, in particular from 800 to 4,000, preferably having an average functionality of from 1.8 to 2.6, preferably from 1.9 to 2.2, in particular 2, examples being polyesteroles, polyetheroles and/or polycarbonatediols. Preference is given to the use of polyesterdiols, these being obtainable via reaction of butanediol and hexanediol, as diol, with adipic acid, as dicarboxylic acid, the ratio by weight of butanediol to hexanediol preferably being 2:1. Preference is also given to polytetrahydrofuran with a molar mass of from 750 to 2,500 g/mol, preferably from 750 to 1,200 g/mol.

Well-known compounds may be used as chain extenders, examples being diamines and/or alkanediols having from 2 to 10 carbon atoms in the alkylene radical, in particular ethylene glycol and/or 1,4-butanediol, and/or hexanediol, and/or di- and/or trioxyalkylene glycols having from 3 to 8 carbon atoms in the oxyalkylene radical, and preferably corresponding oligo-polyoxypropylene glycols, and use may also be made here of mixtures of the chain extenders. Other chain extenders which may be used are 1,4-bis(hydroxymethyl)benzene (1,4-BHMB), 1,4-bis(hydroxyethyl) benzene (1,4-BHEB), or 1,4-bis(2-hydroxyethoxy) benzene (1,4-HQEE). Preferred chain extenders used are ethylene glycol and hexanediol, ethylene glycol being particularly preferred.

It is usual to use catalysts which accelerate the reaction between the NCO groups of the diisocyanates and the hydroxyl groups of the structural components, examples being tertiary amines, such as triethylamine, dimethylcyclohexylamine, N-methylmorpholine, N,N′-dimethylpiperazine, 2-(dimethylaminoethoxy)ethanol, diazabicyclo(2.2.2)octane, and the like, and also in particular organometallic compounds, such as titanic esters, iron compounds, e.g. iron(III) acetylacetonate, tin compounds, such as stannous diacetate, stannous dilaurate, or the dialkyl tin salts of aliphatic carboxylic acids, e.g. dibutyltin diacetate, dibutyltin dilaurate, or the like. The usual amounts used of the catalysts are from 0.0001 to 0.1 parts by weight for each 100 parts by weight of polyhydroxy compound.

Besides catalysts, conventional auxiliaries may also be added to the structural components. By way of example, mention may be made of surface-active substances, flame retardants, nucleating agents, lubricants, mold-release agents, dyes and pigments, inhibitors, hydrolysis stabilizers, light stabilizers, heat stabilizers, oxidation retarders or discoloration stabilizers, preservatives to counter microbial degradation, inorganic and/or organic fillers, reinforcing agents, and plasticizers.

To adjust the molecular weight, use may be made of monofunctional compounds reactive toward isocyanate, preferably monoalcohols.

The TPUs are usually prepared by conventional processes, for example by means of belt systems or reactive extruders.

To produce the expanded TPUs, the TPUs are mixed with the expandable microspheres and subjected to thermoplastic processing to give the desired moldings. By way of example, this processing may take place by means of injection molding, sintering, or extrusion. The temperature prevailing during the thermoplastic processing results in expansion of the expandable microspheres and thus in formation of the expanded TPUs. The melt is preferably introduced into molds and solidified or recrystallized.

The mixing of the TPUs or TPU blends with the expandable microsphere powders may take place in simple plastics pellet mixers, e.g. tumbling mixers, with or without prior application of from 0.05 to 2% of binders, e.g. paraffin oil or mineral oil. The mixing of the TPUs or TPU blends with the expandable microsphere masterbatches may likewise take place in simple plastics pellet mixers, e.g. in tumbling mixer machines, or may take place manually in simple plastics containers, to give what is known as a dry blend.

By way of example, the inventive expanded TPUs may be used in the form of films, hoses, profiles, fibers, cables, shoe soles, other shoe parts, tags, automobile parts, agricultural products, electrical products, damping components; armrests; plastics furniture components, ski boots, impact absorbers, rollers and pulleys, ski goggles, and powder-slush surfaces. According to the invention, preference is given to shoe soles, in particular to those with a compact skin and with a foamed core, in particular colored, and in particular black-colored, shoe soles. According to the invention it is also possible to foam light-resistant aliphatic TPUs or blends composed thereof. Examples are provided by products for the interior and exterior of automobiles, e.g. instruments panel surfaces, gearshift knobs, controls and control knobs, antennas and antenna bases, handles, housings, switches, coverings, and components of coverings, etc.

The present invention therefore also provides expanded thermoplastic polyurethanes, in particular shoe soles, in particular with a compact skin and with a foamed core, comprising expanded microspheres with an initial TMA density smaller than 10 kg/m³.

The invention will be described in further detail in the examples below.

Results

The table shown gives the results from this invention.

| Experiment | Elastollan | Expandable | ST_{MP} | TMA D | PW_{MP-MB} | Chemical | ST_{CBA} | PW_{CBA} | | Feed |
|---|---|---|---|---|---|---|---|---|---|---|
| number | (TPU) | Microspheres | [° C.] | [kg/m³] | [%] | BA | [° C.] | [%] | Process | [° C.] |
| R0* | S70A10W | | | | | | | | I | 160 |
| R1 | S70A10W | | | | | CT460 | 120 | 3 | I | 100 |
| R2 | S70A10W | 092MB120 | 116-126 | <14 | 3 | CT460 | 120 | 3 | I | 100 |
| R3 | S70A10W | 092MB120 | 116-126 | <14 | 3 | CT460 | 120 | 3 | I | 100 |
| R4 | S70A10W | 092MB120 | 116-126 | <14 | 3 | CT460 | 120 | 3 | I | 100 |
| R5 | S70A10W | 092MB120 | 116-126 | <14 | 6 | | | | I | 100 |
| R6 | S70A10W | 092MB120 | 116-126 | <14 | 3 | | | | I | 100 |

| | Heating | Heating | Heating | Heating | Heating | | Density | | |
|---|---|---|---|---|---|---|---|---|---|
| Experiment | zone 1 | zone 2 | zone 3 | zone 4 | zone 5 | Die | [g/cm³] | | |
| number | [° C.] | [° C.] | [° C.] | [° C.] | [° C.] | [° C.] | DIN 53479 | Cavities | Depressions |
| R0* | 170 | 180 | 190 | | | 185 | 1.20 | 0 | 0 |
| R1 | 160 | 165 | 170 | | | 150 | n.d. | ++ | ++ |
| R2 | 160 | 165 | 170 | | | 150 | 0.70 | + | + |
| R3 | 165 | 170 | 175 | | | 155 | n.d. | ++ | ++ |
| | | | | | | | collapse | | |
| R4 | 155 | 160 | 165 | | | 145 | n.d. | + | ++ |
| | | | | | | | Mold not | | |
| | | | | | | | filled | | |
| R5 | 165 | 175 | 180 | | | 170 | 0.71 | 0 | 0 |
| R6 | 165 | 175 | 180 | | | 170 | 0.96 | 0 | 0 |

*Hold pressure was used only for R0 and R5

| Experiment | Elastollan | Expandable | ST_{MP} | TMA D | PW_{MP-MB} | Chemical | ST_{CBA} | PW_{CBA} | | Feed |
|---|---|---|---|---|---|---|---|---|---|---|
| number | (TPU) | Microspheres | [° C.] | [kg/m³] | [%] | BA | [° C.] | [%] | Process | [° C.] |
| 1 | S70A10W | MB1 | 116-126 | <6 | 3 | | | | I | 100 |
| 2 | S70A10W | MB1 | 116-126 | <6 | 3 | | | | I | 100 |
| 3 | S70A10W | MB1 | 116-126 | <6 | 3 | | | | I | 100 |
| 4 | S70A10W | MB1 | 116-126 | <6 | 6 | | | | I | 100 |
| R5* | Blend1 | | | | | | | | I | 160 |
| R6 | Blend1 | | | | | CT460 | 120 | 5 | I | 100 |
| R7 | Blend1 | 092MB120 | 116-126 | <14 | 3 | CT460 | 120 | 3 | I | 100 |
| R8 | Blend1 | 092MB120 | 116-126 | <14 | 3 | CT460 | 120 | 3 | I | 100 |
| R9 | Blend1 | 092MB120 | 116-126 | <14 | 3 | CT460 | 120 | 3 | I | 100 |

| | Heating | Heating | Heating | Heating | Heating | | Density | | |
|---|---|---|---|---|---|---|---|---|---|
| Experiment | zone 1 | zone 2 | zone 3 | zone 4 | zone 5 | Die | [g/cm³] | | |
| number | [° C.] | [° C.] | [° C.] | [° C.] | [° C.] | [° C.] | DIN 53479 | Cavities | Depressions |
| 1 | 155 | 160 | 165 | | | 150 | 0.71 | 0 | 0 |
| 2 | 160 | 165 | 170 | | | 155 | 0.68 | 0 | 0 |
| 3 | 150 | 155 | 160 | | | 145 | 0.75 | 0 | 0 |
| 4 | 155 | 160 | 165 | | | 150 | 0.61 | 0 | 0 |
| R5* | 170 | 180 | 190 | | | 185 | 1.17 | 0 | 0 |
| R6 | 160 | 165 | 170 | | | 150 | n.d. | ++ | ++ |
| R7 | 160 | 165 | 170 | | | 150 | 0.69 | + | + |
| R8 | 165 | 170 | 175 | | | 155 | n.d. | ++ | ++ |
| | | | | | | | collapse | | |
| R9 | 155 | 160 | 165 | | | 145 | n.d. | + | ++ |
| | | | | | | | Mold not | | |
| | | | | | | | filled | | |

*Hold pressure was used only for R0 and R5

| Experiment | Elastollan | Expandable | ST_{MP} | TMA D | PW_{MP-MB} | Chemical | ST_{CBA} | PW_{CBA} | | Feed |
|---|---|---|---|---|---|---|---|---|---|---|
| number | (TPU) | Microspheres | [° C.] | [kg/m³] | [%] | BA | [° C.] | [%] | Process | [° C.] |
| R10 | Blend1 | 092MB120 | 116-126 | <14 | 6 | | | | I | 100 |
| R11 | Blend1 | 092MB120 | 116-126 | <14 | 3 | | | | I | 100 |
| 5 | Blend 1 | MB1 | 116-126 | <6 | 3 | | | | I | 100 |
| 6 | Blend 1 | MB1 | 116-126 | <6 | 3 | | | | I | 100 |
| 7 | Blend 1 | MB1 | 116-126 | <6 | 3 | | | | I | 100 |
| 8 | Blend 1 | MB1 | 116-126 | <6 | 3 | | | | I | 100 |
| 9 | 1180A10 | MB1 | 116-126 | <6 | 3 | | | | E | 100 |
| 10 | 1180A10 | MB1 | 116-126 | <6 | 6 | | | | E | 100 |

| | Heating | Heating | Heating | Heating | Heating | | Density | | |
|---|---|---|---|---|---|---|---|---|---|
| Experiment | zone 1 | zone 2 | zone 3 | zone 4 | zone 5 | Die | [g/cm³] | | |
| number | [° C.] | [° C.] | [° C.] | [° C.] | [° C.] | [° C.] | DIN 53479 | Cavities | Depressions |
| R10 | 165 | 175 | 150 | | | 170 | 0.67 | 0 | 0 |
| R11 | 165 | 175 | 150 | | | 170 | 0.89 | 0 | 0 |
| 5 | 165 | 175 | 150 | | | 170 | 0.68 | 0 | 0 |
| 6 | 170 | 180 | 155 | | | 175 | 0.66 | 0 | 0 |
| 7 | 160 | 170 | 145 | | | 165 | 0.77 | 0 | 0 |
| 8 | 165 | 175 | 150 | | | 170 | 0.57 | 0 | 0 |
| 9 | 145 | 160 | 165 | 165 | 155 | 145 | 0.63 | 0 | 0 |
| 10 | 145 | 160 | 165 | 165 | 155 | 145 | 0.50 | 0 | 0 |

*Hold pressure was used only for R0 and R5
Key:
R = Reference experiment
MP = Microspheres
092MB120 Microsphere masterbatch from Akzo composed of 65% of 092DU120 (microsphere powder from Akzo) in EVA as carrier
MB = Masterbatch
MB1 = Microsphere masterbatch composed of 65% 093DU120 (microsphere powder, Akzo) in 35% of EVA Escorene Ultra (ExxonMobil), melt index 150 g/10 min (ASTM D1238), prepared on a compounding plant at from 80 to 100° C.
ST_{MP} = Start temperature at which the microspheres begin to expand
TMA D = TMA density measured on the microsphere powder incorporated into the masterbatch: minimum achievable density [kg/m³] prior to collapse of microspheres; Mettler Toledo Stare thermal analysis system; heating rate 20° C./min; specimen weight about 0.5 mg
PW_{MP-MB} = Proportion by weight of microsphere masterbatch used, based on TPU
CBA = Chemical blowing agent
ST_{CBA} = Start temperature at which the chemical blowing agent begins to expand
PW_{CBA} = Proportion by weight of chemical blowing agent masterbatch used, based on TPU
Process = Type of thermoplastic processing
I = Injection molding on Klöckner Ferromatic; mold temperature = 25° C.; shoe mold; Shot weight 178 g at density 1.20 g/cm³ for Elastollan S70A10W
E = Extrusion using profile die on Thyssen Henschel Ø 60 mm; screw ratio 1:2.5
Cavities = Assessment of cavities in cross section, always at the thickest point of the finished part
0 = no cavities
0+ = very small cavities
+ = clearly discernible cavities
++ = extremely significant cavitation
Depressions = Depressions in surface of finished part
0 = no depressions
0+ = very small depressions
+ = clearly discernible depressions
++ = extremely significant depressions
n.d = could not be determined because cell structure was highly heterogeneous and irregular with significant cavitation
CT460 = Hydrocerol CT460; Clariant; chemical blowing agent masterbatch
S70A10W = Commercially available polyester TPU, plasticized, from Elastogran GmbH; example of use: shoe soles
Blend 1 = Blend composed of 80% by weight of Elastollan ® S80A10 from Elastogran GmbH and 20% by weight of Chemigum ® 615D from Eliochem, prepared on Ø 43 mm twin-screw extruder
Elastollan ® 1180A10 = commercially available polyester TPU 80ShA from Elastogran GmbH

As can be seen from the table above, in the case of a mixture composed of chemical blowing agent and expandable microspheres a temperature increase of only 5° C. leads to collapse of the cell structure, and when the process temperature is lowered by 5° C. the result is incomplete filling of the mold. If variations occur outwith the ideal processing latitude, this always leads to problems. However, it is never possible completely to prevent formation of cavities and depressions.

If use is made of expandable microspheres alone, these having a low TMA density smaller than 10 kg/m³, preferably from 2 to 10 kg/m³ and particularly preferably from 2 to 7 kg/m³, the narrow processing latitude described above does not arise, as demonstrated by the above experiments.

Indeed, in the case of the MB1 masterbatch with its very low TMA density of <6 kg/m³, the amount of the blowing agent can be reduced by half when comparison is made with 092MB120.

The results achieved are obtained irrespective of whether the starting material is microsphere powder or microsphere masterbatch.

We claim:

1. An expandable thermoplastic polyurethane, comprising expandable microspheres whose TMA density is smaller than 10 kg/m³.

2. The expandable thermoplastic polyurethane according to claim 1, capable of fabrication via mixing of thermoplastic polyurethanes with expandable microspheres, wherein the expandable microspheres have a TMA density of from 2 to 10 kg/m³.

3. The expandable thermoplastic polyurethane according to claim 1, capable of fabrication via mixing of thermoplastic polyurethanes with expandable microspheres, wherein the expandable microspheres have a TMA density of from 2 to 7 kg/m³.

4. The expandable thermoplastic polyurethane according to claim 1, which comprises, based on the mixture, from 0 to 50% by weight of plasticizer.

5. The expandable thermoplastic polyurethane according to claim 1, wherein the thermoplastic polyurethane used comprises a blend composed of thermoplastic polyurethane and, based on the weight of the blend, from 0 to 70% by weight of another plastic from the group of the thermoplastics, in particular from the group of the thermoplastic elastomers or rubbers.

6. The expandable thermoplastic polyurethane according to claim 1, which comprises the following components:
from 90 to 99.5% by weight of TPU or a blend comprising TPU,
from 0.5 to 10% by weight of masterbatch comprising expandable microspheres,
from 0 to 10% by weight of dye.

7. A process for producing a thermoplastic polyurethane, comprising the steps of
a) mixing blowing agents with thermoplastic polyurethanes and, where appropriate, drying
b) thermoplastic processing of this mixture with expansion of the blowing agent,
which comprises using, as blowing agents, expandable microspheres with a TMA density smaller than 10 kg/m³, preferably from 2 to 10 kg/m³, and particularly preferably from 2 to 7 kg/m³.

8. An expanded thermoplastic polyurethane, capable of production according to claim 7.

9. The expanded thermoplastic polyurethane according to claim 7, which has a density of <1.2 g/cm³.

10. The expanded thermoplastic polyurethane according to claim 8, which has a density in the range from 0.2 to 1.0 g/cm³.

11. An expanded thermoplastic polyurethane, in particular a shoe sole, in particular with a compact skin and with a foamed core, comprising expanded microspheres with an initial TMA density smaller than 10 kg/m³.

12. A masterbatch comprising from 5 to 80% by weight, preferably from 25 to 65% by weight, of microspheres, and from 20 to 95% by weight, preferably from 35 to 75% by weight, of thermoplastic carrier, in particular EVA (ethylene-vinyl acetate).
